(19) United States
(12) Patent Application Publication
(10) Pub. No.: US 2004/0019765 A1
(43) Pub. Date: Jan. 29, 2004

(54) Pipelined reconfigurable dynamic instruction set processor

(76) Inventor: Robert C. Klein JR., Macungie, PA (US)

Correspondence Address: Pepper Hamilton LLP, One Mellon Center, 50th Floor, 500 Grant Street, Pittsburgh, PA, 15219, US

(21) Appl. No.: 10/625,889

(22) Filed: Jul. 23, 2003

Related U.S. Application Data
(60) Provisional application No. 60/398,150, filed on Jul. 23, 2002.

(51) Int. Cl. G06F 15/00

(52) U.S. Cl. 712/15

(57) ABSTRACT

A reconfigurable processor for processing digital logic functions includes a microcontroller, one or more decoders connected to the microcontroller, a plurality of interconnection busses; and a plurality of processing elements is described. Each processing element connects to one or more other processing elements by local interconnection paths and to a decoder. The plurality of processing elements are arranged in one or more pipeline stages each including one or more processing elements. A method of dynamically reconfiguring a pipelined processor including configuring, using a microcontroller, a plurality of pipeline stages each including one or more processing elements, processing data through one or more pipeline stages, reconfiguring, by the microcontroller, one or more pipeline stages to define one or more subsequent pipeline stages, and routing the processed data through the one or more reconfigured pipeline stages is also described. The reconfiguration may take place while data is processed by other pipeline stages.

### CLAIM OF PRIORITY

This application claims priority to, and incorporates by reference in its entirety, the U.S. provisional patent application No. 60/398,150, filed Jul. 23, 2002.

### FIELD OF THE INVENTION

The invention generally relates to semiconductor digital logic and, more specifically, to semiconductor digital circuitry implementing a pipelined dynamically reconfigurable instruction set processor.

### BACKGROUND OF THE INVENTION

Central Processing Units (CPUs), such as microprocessors, microcontrollers, and digital signal processors (DSPs), have often been implemented in silicon. The functionality of such devices can and has been incorporated, in whole or in part, into other silicon devices such as Application Specific Integrated Circuits (ASICs) and Field Programmable Gate Arrays (FPGAs). Typically, such devices are found in products ranging from supercomputers to cellular telephones to children's toys. Consumers have demanded the development of new electronic products that are smaller, lighter, and less expensive, but which offer more processing power, more features, and longer battery life. These conflicting design goals have strained the capabilities of traditional semiconductor technologies and chip architectures.

A significant limitation of conventional CPUs and CPU-related devices is that dedicated resources, such as silicon, are required to implement a specific task or “instruction” that is performed. For example, the Intel® Pentium® 4 processor executes over 440 different instructions, of which 144 are new instructions (for SIMD or “Streaming Single-Instruction/Multiple-Data”) as compared to the Intel® Pentium® III processor. Increasing the number of instructions in the instruction set, adding on-chip memory, and implementing new features increases the physical size of the microprocessor. Larger die sizes result in higher costs and higher power requirements. Higher power requirements, in turn, are equivalent to a shorter battery life, particularly in mobile or wireless systems. Further compounding the problem, any instruction logic or other on-chip resources that are not used in a given application are simply wasted while the processor is executing that application.

Another limitation of conventional computational circuit devices is that internal and external busses have fixed bit widths. Unless all data that is germane to a given application is efficiently expressed in words that match the bus width of the microprocessor, waste caused by underutilization of the bus, or looping caused by the separation of large data sets into smaller parts on which the processor sequentially operates, results. For example, the Intel® Pentium® 4 processor has a 32-bit data bus. Processing an entire video line of 640 pixels requires a minimum of 20 (640/32 bits=20) bus transactions. Conversely, reading a single-bit value (e.g., an ON/OFF switch) also requires a full 32-bit bus for execution. Similarly, in other real world applications, data types vary widely. For example, individual bits may be transferred as a result of key presses or mouse click inputs, bytes of data may be transferred when outputting ASCII characters, and massive data widths may be required for digital video, audio, and Internet/network data. Conventional computational circuit devices are not well equipped to handle data types, such as these, possessing such fundamentally different characteristics.

A further limitation of conventional computational circuit devices relates to power consumption. Mobile and wireless computing and communications devices are particularly sensitive to power and battery life. The aforementioned limitations imposed by fixed instruction sets and fixed bus widths have a severe negative impact on battery life because of underutilization of the internal components of these devices or their busses. In non-mobile environments, the need to dissipate heat generated by these devices has increased to the point where a substantial heat sink is required. Further dissipation requires the addition of a local fan. The cost of these sinks and fans along with their footprint on the integrated circuit board and volume in the enclosure become a significant consideration when dealing with high performance processors.

Embedding CPU functionality in ASICs or FPGAs does not resolve the limitations of having a fixed bus-width or a fixed instruction set. Moreover, such devices may be more costly and may require longer design cycles. The performance benefits of application specific silicon logic are well known; by customizing the logic functions to the desired application, a more compact, lower power, and higher performance solution may be obtained. However, even full-custom solutions typically use a small percentage of their available logic capacity at any given instant.

What is needed is a logic circuit that substantially departs from the limitations of ASICs, FPGAs, and CPUs. What is needed is an apparatus primarily designed to accommodate digital logic processing functions in products that demand the highest levels of performance with small size, low cost, and low power consumption.

### SUMMARY OF THE INVENTION

In view of the foregoing disadvantages inherent in the known types of CPUs and application specific silicon logic devices, the present invention provides a new silicon-based architecture and construction where the architecture may satisfy the conflicting imperatives—high computing performance at low size, cost and power consumption—demanded by shrinking portable, wireless and internet-connected devices.

The general purpose of the present invention, which will be described subsequently in greater detail, is to provide a new semiconductor digital logic device referred to herein as a pipelined reconfigurable dynamic instruction set processor (DISP) that has many of the advantages of the CPU mentioned heretofore and novel features that result in a new device type, architecture, and construction.

In a preferred embodiment of the present invention, the reconfigurable processor for processing digital logic functions includes a microcontroller, preferably one or more decoders connected to the microcontroller, a plurality of interconnection busses; and a plurality of processing elements. Each processing element is connected to one or more other processing elements by one or more local interconnection paths and is connected to one of the one or more decoders. The plurality of processing elements are arranged in one or more pipeline stages each comprising one or more processing elements. The microcontroller has a program that performs the steps of configuring the plurality of processing elements by sending configuration information via the one or more decoders, determining whether the processing elements in one or more pipeline stages have processed data, and reconfiguring, after data has been processed by the processing elements of a pipeline stage, the processing elements in the pipeline stage to define a subsequent pipeline stage. In an alternate embodiment, the processor further includes one or more global interconnection busses used to connect the plurality of processing elements to the one or more decoders.

In a preferred embodiment of the present invention, a method of dynamically reconfiguring a pipelined reconfigurable dynamic instruction set processor includes configuring, by a microcontroller, a plurality of pipeline stages, wherein each pipeline stage includes one or more processing elements, processing data through one or more of the plurality of pipeline stages, reconfiguring, by the microcontroller, at least one of the one or more pipelined stages to define at least one subsequent pipeline stage, and routing the processed data through the at least one reconfigured pipeline stage. In an alternate embodiment, the reconfiguring step is performed while the processed data is processed by at least one pipeline stage of the plurality of pipelined stages.

There has thus been outlined, rather broadly, the more important features of the invention in order that the detailed description thereof may be better understood, and in order that the present contribution to the art may be better appreciated. There are additional features of the invention that will be described hereinafter.

In this respect, before explaining at least one embodiment of the present invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the terminology herein employed is for the purpose of the description and should not be regarded as limiting.

### BRIEF DESCRIPTION OF THE DRAWINGS

Various other objects, features, and attendant advantages of the present invention will become fully appreciated as the same becomes better understood when considered in conjunction with the accompanying drawings, in which the reference characters designate the same or similar parts throughout the several views.

FIG. 1 depicts an exemplary block diagram of the digital set instruction processor according to an embodiment of the present invention.

FIG. 2 illustrates a method of performing pipelined reconfiguration of processing elements according to an embodiment of the present invention.

FIG. 3 is a general block diagram that illustrates a preferred embodiment of a three-dimensional interconnect structure realized in a two-dimensional medium. An eight-row by eight-column array is shown as an illustrative example.

FIG. 4 depicts a three-dimensional conceptual view of the toroidal and system bus connections.

FIG. 5 illustrates an exemplary block diagram of a processing element according to an embodiment of the present invention.

### DESCRIPTION OF THE PREFERRED EMBODIMENTS

Before the present methods are described, it is to be understood that this invention is not limited to the particular methodologies or protocols described, as these may vary. It is also to be understood that the terminology used in the description is for the purpose of describing the particular versions or embodiments only, and is not intended to limit the scope of the present invention which will be limited only by the appended claims. In particular, although the present invention is described in conjunction with a silicon-based integrated circuit, it will be appreciated that the present invention may find use in any integrated circuit design.

It must also be noted that as used herein and in the appended claims, the singular forms “a”, “an”, and “the” include plural references unless the context clearly dictates otherwise. Thus, for example, reference to a “processing element” is a reference to one or more processing elements and equivalents thereof known to those skilled in the art, and so forth. Unless defined otherwise, all technical and scientific terms used herein have the same meanings as commonly understood by one of ordinary skill in the art. Although any methods similar or equivalent to those described herein can be used in the practice or testing of embodiments of the present invention, the preferred methods are now described. All publications mentioned herein are incorporated by reference. Nothing herein is to be construed as an admission that the invention is not entitled to antedate such disclosure by virtue of prior invention.

Turning now descriptively to the drawings, in which similar reference characters denote similar elements throughout the several views, the attached figures illustrate a pipelined reconfigurable dynamic instruction set processor (DISP), which may include an on-chip microcontroller for basic processing and management of the reconfigurable fabric, one or more decoders, a plurality of local interconnection paths, and a plurality of processing elements.

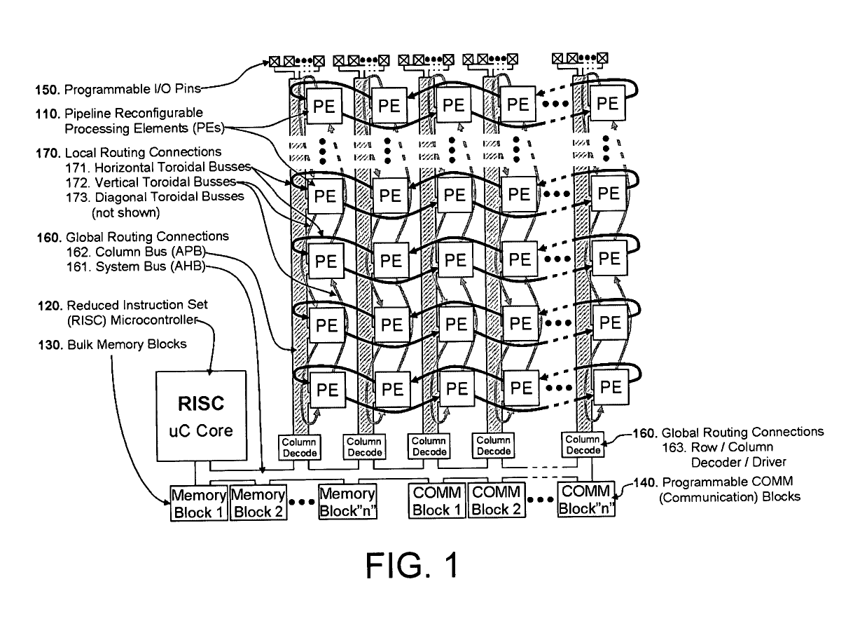

FIG. 1 depicts an exemplary block diagram of the digital instruction set processor according to an embodiment of the present invention. The DISP device may include a Reduced Instruction Set Computer (RISC) microcontroller 120 for performing logic functions. In one embodiment, the ARM9TDMi from ARM, Ltd. may be used as the RISC microcontroller 120, although other microcontrollers also may be used. The RISC microcontroller 120 may possess a small instruction set, a load/store architecture, fixed length coding and hardware decoding, and a large register set. The RISC microcontroller 120 may perform delayed branching and maintain processor throughput of approximately one instruction per cycle on average. The RISC microcontroller 120 may execute instructions in its native instruction set and may manage a plurality of reconfigurable processing elements and other on-chip resources.

The RISC microcontroller 120 may reside in the same physical silicon as the remainder of the DISP device described herein, or it may be external thereto. Where the RISC microcontroller is external to the silicon embodying the remainder of the invention, the signals required for control of the DISP device may be connected to one or more input/output pins 150 and/or one or more communication blocks 140.

When the DISP device is programmed to perform an application, a portion of the available tasks may be performed by the RISC microcontroller 120 and the remainder may be performed by the reconfigurable processing elements (or “PEs”) 110. Instructions performed by the PEs 110 may be of arbitrary size. Particularly in high-performance and scientific applications, the bulk of a processing task may be concentrated in a few lines of code, embedded in the “inner loop” of a program. Examples of applications where this occurs may include digital signal processing, encryption and decryption algorithms, video processing, and data communications. In a preferred embodiment, these concentrated tasks may be performed by the reconfigurable PEs 110 of the DISP device. The RISC microcontroller 120 may be used to manage the reconfigurable PEs 110 both spatially and temporally by assigning functions to the PEs 110, managing the flow of data through the fabric, and retiring, relocating, or reformulating instructions for the PEs 110 as required by the application.

The RISC microcontroller 120 may also be used to perform a power-up/boot sequence that may include testing of the other on-chip functions and resources. The basic boot functionality may be hard-coded into the RISC microcontroller 120 or other portions of the DISP device, but an option to override the default boot code may be provided.

The COMM (communication) blocks 140 may include circuitry for packetizing and depacketizing, sending, and receiving serial data streams. The COMM blocks 140 may be programmed to support a plurality of communication protocols at various data rates and may also provide clock and data recovery. The COMM blocks may connect to the plurality of PEs 110 and other components through Global Routing resources 160. The COMM blocks 140 may be configured by the RISC microcontroller 120.

One or more memory blocks 130 may be included in the DISP device. The memory blocks 130 may be synchronous and/or asynchronous Static or Dynamic Random Access Memory (SRAM and/or DRAM), FLASH-type memory, and/or other types of semiconductor memory. The memory blocks 130 may be segmented into smaller blocks or cascaded to create larger blocks. In a preferred embodiment, the memory blocks 130 may be high-speed, 2K×8 dual-ported memories with one such memory used in conjunction with each of the one or more decoders 163. The RISC microcontroller 120 may optionally configure the memory blocks 130 to function as single or dual-ported SRAM, Content Addressable Memory (CAM), First-In-First-Out (FIFO) memory or Last-In-First-Out (LIFO) memory. The memory blocks 130 are not limited to the size described in the preferred embodiment, but may be of any size with any number of addressable regions. In addition, the memory blocks 130 may be implemented in non-SRAM, such as FLASH, EEPROM, and DRAM.

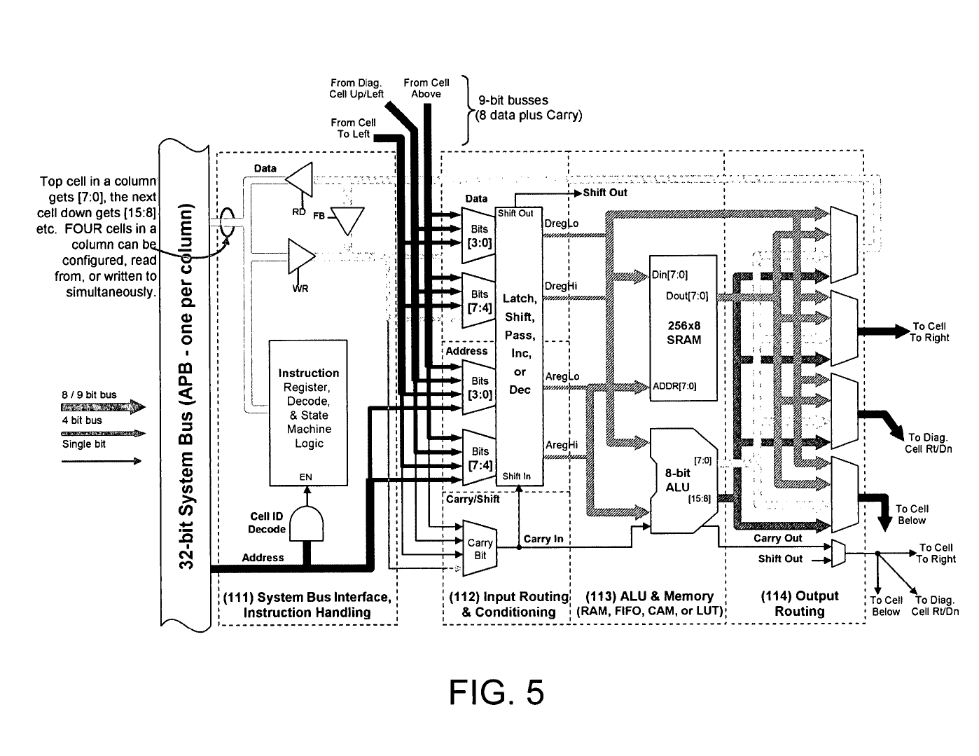

The DISP device may include a plurality of reconfigurable PEs 110. Referring to FIG. 5, in a preferred embodiment, each PE 110 may include a System Bus Interface/Instruction Handling block 111, an Input Routing and Conditioning block 112, an ALU/Memory block 113, and/or an Output Routing block 114. Returning to FIG. 1, the System Bus Interface/Instruction Handling block 111 may be used to transfer data and instructions between the Global Routing resources 160 and the PE 110. In a preferred embodiment, the Input Routing and Conditioning block 112 may select data from one of, for example, four data sources and may condition the incoming data by performing one or more functions on it including, without limitation, latching, passing, shifting, incrementing or decrementing the data. The ALU/Memory block 113 may perform functions including, but not limited to, an arithmetic function, a memory lookup function, or a memory store function. The Output Routing block 114 may pass the resulting data to, for example, the Global Routing resources 160, subsequent PEs, or the same PE 110. The operation and hardware of the PE 110 are covered in more detail in the description of FIG. 5.

The Global Routing resources 160 may connect the PEs 110 to the other primary system components. In an embodiment, the Global Routing resources 160 may include one primary bus 161 and multiple secondary busses 162. Each bus may include, for example, capacity to handle up to 32 bits of data, address bits, and control bits. Data busses of differing sizes may alternatively be used. The primary bus 161 may connect to the plurality of secondary busses 162 by using programmable decoders 163. In a preferred embodiment, each programmable decoder 163 may correspond to one column of PEs 110 connected to the same secondary bus 162. Each programmable decoder 163 may decode the address lines on the primary bus 161 to determine whether the destination of the current instruction is connected to the secondary bus 162 with which the decoder 163 is associated. The decoders 163 and the secondary busses 162 may thus enable the RISC microcontroller 120 to communicate with the PEs 110. The decoders 163 and the secondary busses 162 may also provide programmable connections to the general purpose input/output (I/O) pins 150, the memory blocks 130, and/or the COMM blocks 140.

In a preferred embodiment, the primary global bus 161 and the secondary global busses 162 are implemented to conform with the ARM Advanced Microcontroller Bus Architecture (AMBA) as described in the AMBA specification, document number ARM IHI 0011A from ARM, Ltd. This document describes the AHB (Advanced High-Performance Bus) and the APB (Advanced Peripheral Bus). In the preferred embodiment of the DISP device, the AHB may be used as the primary system bus (horizontal) 161 and the APBs may be the secondary busses (vertical) 162 that connect to the PEs 110. The APB may be subdivided along byte boundaries to communicate with four contiguous PEs 110 simultaneously.

In alternate embodiments, other RISC microcontrollers 120 may be used as part of the DISP device. Alternate Global Routing resources 160 may be specified for use with these alternate RISC microcontrollers 120. As such, the description of the preferred embodiment is not meant to be limiting, but merely to describe one manner of connecting a RISC microcontroller 120 and Global Routing resources 160 for a DISP device.

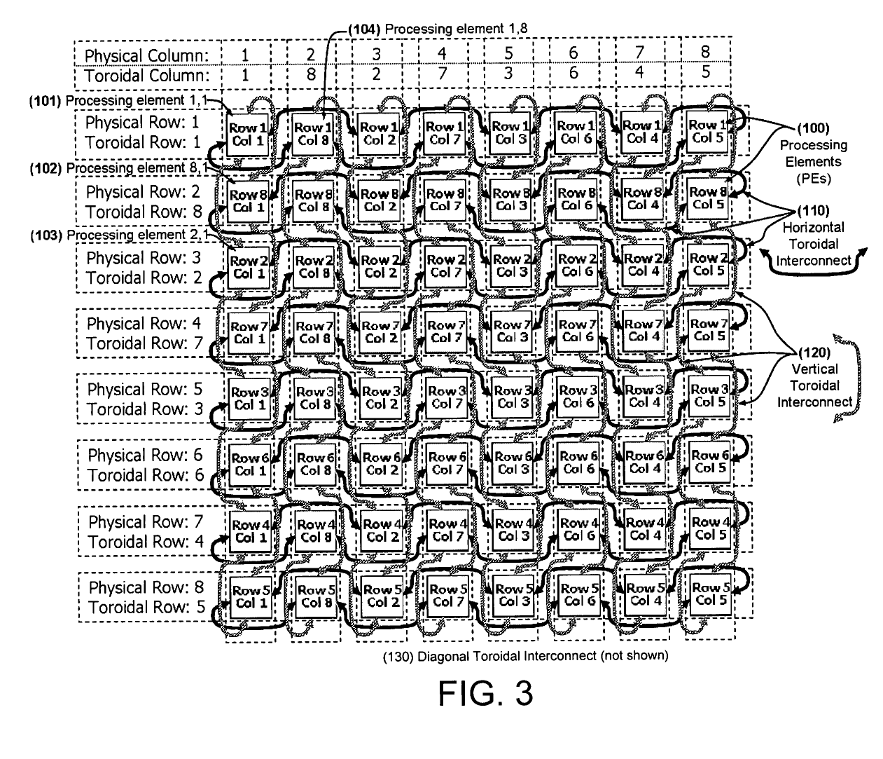

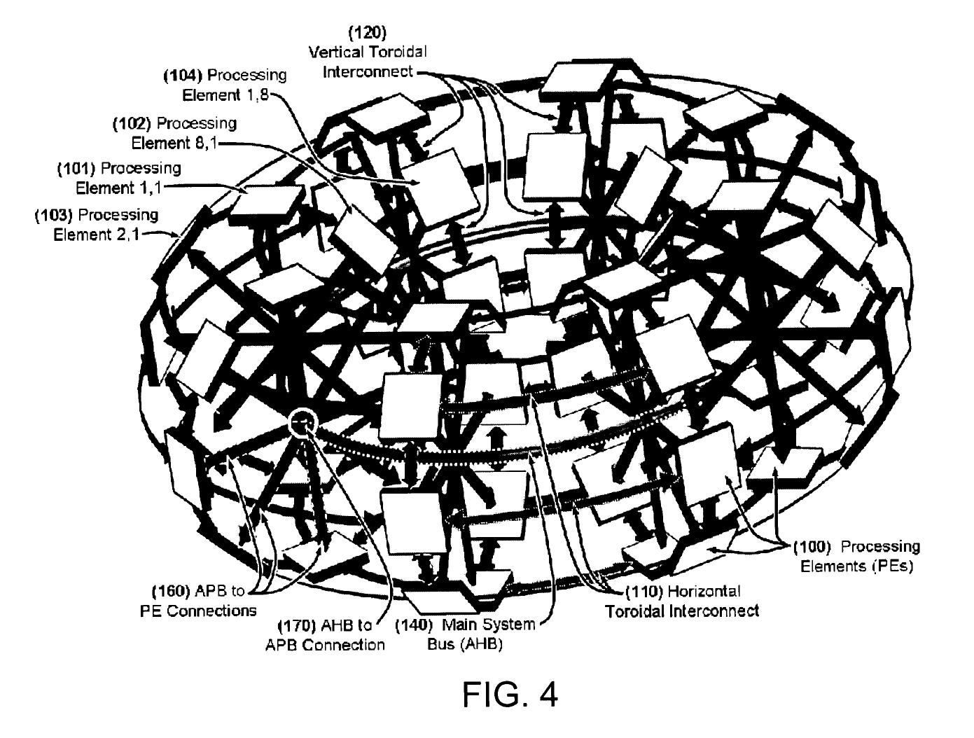

The Local Routing connections 170 may interconnect the individual PEs 110. In a preferred embodiment, the two-dimensional interconnection of the PEs 110 may conceptually resemble a toroid, as depicted in FIGS. 3 and 4. In FIGS. 3 and 4, the horizontal routing busses 171 and the vertical routing busses 172 are depicted as single line connections for clarity. However, each of these busses may be of any bit width. In a preferred embodiment, the busses may be nine bits wide (eight signals plus a carry/cascade signal), supporting up to 18-bit word widths to and from a single PE 110. In addition, diagonal routing busses 173 may also be implemented. The Local Routing connections 170 may connect the Output Routing block 114 of a PE 110 with the Global Routing resources 160 and the Input Routing and Conditioning block 112 of specific neighboring PEs 110. In an embodiment, the Local Routing connections 170 may also provide direct feedback to the Input Routing and Conditioning block 112 of the same PE 110. In a preferred embodiment, the Local Routing connections 170 for a given PE 110 may be used to drive the Input Routing and Conditioning blocks 112 of the PEs along an x-axis (e.g., to the right), along a y-axis (e.g., below), and diagonally (e.g., to the right and below) the PE 110 within the interconnect structure. The toroidal interconnect structure of the preferred embodiment is described in a co-pending U.S. patent application, entitled “Improved Interconnect Structure for Electrical Devices,” filed Jul. 23, 2003 with serial No. (not yet assigned), which is incorporated herein by reference in its entirety. PEs 110 that are “adjacent” in the toroidal interconnect structure may not be physically adjacent within the DISP device.

The Input/Output (I/O) pins 150 of the DISP device may be used to connect the device to external components within a larger electronic circuit or system. In an embodiment, the DISP device may be connected to a printed circuit board. In a preferred embodiment, each I/O pin 150, except for pins that function as COMM pins 140, may be programmed to be input pins, output pins or in-out pins. If an I/O pin 150 is configured to be an in-out pin, the pin may have a separate control signal used to drive the pin to a high-impedance state (“tri-state”) to avoid contention and/or excessive power dissipation. The tri-state control signal may originate, without limitation, from a PE 110, the RISC microcontroller 120, one of the COMM pins 140 or another I/O pin 150. The source and destination of an I/O pin 150 and its associated tri-state enable signal (if any) may be determined by the device configuration and may be changed during device operation. The I/O pins 150 may be separated from the PEs 110 and may only connect to the Global Interconnection resources 160. Any transfer of data between the I/O pins 150 and the PEs 110 may be transacted over the secondary global busses 162. Structural and/or functional variations in the I/O framework will be evident to those of skill in the art and are considered to be within the scope of the present invention.

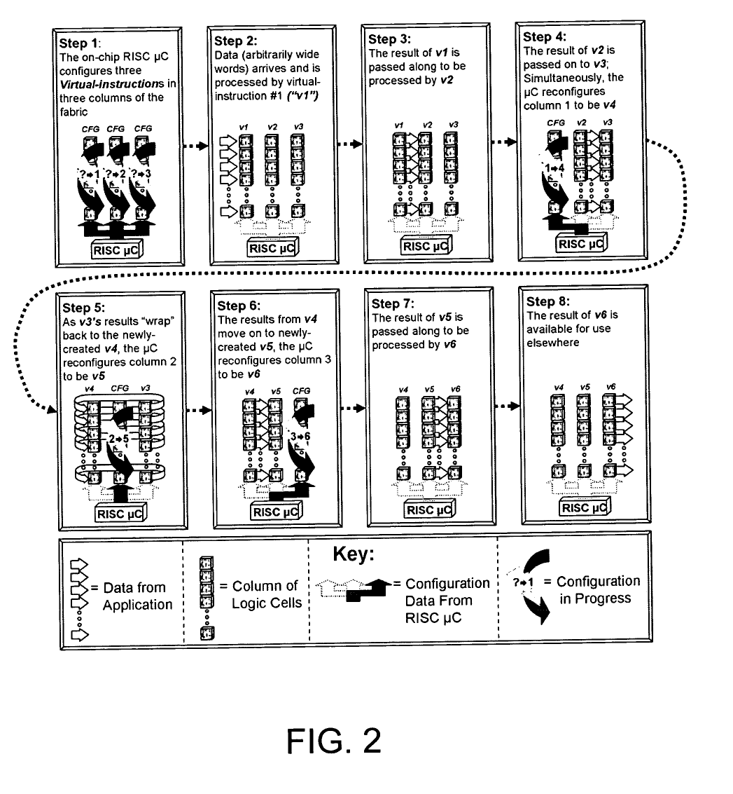

FIG. 2 illustrates a method of performing pipelined reconfiguration of PEs according to an embodiment of the present invention. The method depicted in FIG. 2 is an exemplary visualization of how the array of PEs 110 in a DISP device may be programmed for a simple multi-step set of instructions. In step 1, the RISC microcontroller 120 configures three virtual instructions, one in each of three columns of the array of PEs 110. Note that the use of three instructions and three columns is merely intended to serve as an example, as other numbers of instructions and columns may be used. Each column of the array of PEs 110 may represent, without limitation, a pipeline stage of an application being performed in the DISP device. Data of arbitrary width may then be processed by the PEs 110 configured with the first virtual instruction, as shown in step 2. The data may be received from many sources including, but not limited to, the RISC microcontroller 120, the COMM pins 140, the general purpose I/O pins 150, or other PEs 110. In step 3, the result of the first virtual instruction may be passed to the PEs 110 configured with the second virtual instruction for further processing.

Step 4 depicts two operations in the DISP device. The result of the second virtual instruction may be passed to the PEs 110 configured with the third virtual instruction for further processing. In addition, the RISC microcontroller 120 may reconfigure the PEs 110 configured with the first virtual instruction by loading a configuration for a fourth virtual instruction. The reconfiguration is preferably performed concurrently with the processing of the second virtual instruction.

Step 5 depicts two operations in the DISP device. The result of the third virtual instruction may be passed to the PEs 110 configured with the fourth virtual instruction for further processing. In addition, the RISC microcontroller 120 may reconfigure the PEs 110 configured with the second virtual instruction by loading a configuration for a fifth virtual instruction. The reconfiguration is preferably performed concurrently with the processing of the third virtual instruction.

Step 6 depicts two operations in the DISP device. The result of the fourth virtual instruction may be passed to the PEs 110 configured with the fifth virtual instruction for further processing. In addition, the RISC microcontroller 120 may configure the PEs 110 configured with the third virtual instruction by loading a configuration for a sixth virtual instruction. The reconfiguration is preferably performed concurrently with the processing of the fourth virtual instruction.

In step 7, the result of the fifth virtual instruction may be passed to the PEs 110 configured with the sixth virtual instruction for further processing. In step 8, the result of the sixth virtual instruction may be sent to a destination that is either within or external to the DISP device. For example, the resulting information may be sent to destinations such as the RISC microcontroller 120, the general purpose I/O pins 150, or other PEs 110 in the DISP device.

All pertinent information relative to instruction sets and data flow are described in sufficient detail in this description for those of skill in the art to appreciate the exemplary process. In addition, various modifications to the described process, such as adding to or subtracting from the number of pipeline stages or the number of PEs 110 in each pipeline stage, will be evident to those of skill in the art and are considered to be within the scope of the present invention.

FIG. 5 illustrates an exemplary block diagram of a PE 110 according to an embodiment of the present invention. An individual PE may include the System Bus Interface/Instruction Handler 111 for transferring data and instructions to and from the PE 110, the Input Routing and Conditioning block 112 for selecting the input data from one of, for example, four data sources and performing one or more functions on the input data, the ALU/Memory block 113 for processing or storing the input data, and the Output Routing block 114 for passing the resulting data to, for example, subsequent PEs 110, the RISC microcontroller 120, or general purpose I/O pins 150. Each of these blocks will be described in more detail below.

The System Bus Interface/Instruction Handler 111 may include a cell identification decoder that uniquely identifies a PE 110. When an instruction destined for a given PE 110 is detected, the instruction data may be latched into an instruction register and decoded. The interconnection and functionality of the other blocks of the PE 110 may be configured by the decoded instruction from the instruction register. A state machine may monitor and control the processing steps for launching the instruction. The state machine may launch the instruction once the instruction has been completed.

In a preferred embodiment, multiple PEs 110 maybe configured simultaneously by staggering the data lines of the secondary bus 162 among multiple PEs 110. For example, the uppermost PE 110 in a column may connect to bits 0 through 7 of the secondary bus 162, the PE below it may connect to bits 8 through 15 of the secondary bus 162, and so forth. As such, four PEs 110 may be simultaneously configured, read from, or written to, using a 32-bit secondary bus 162. Alternatively, other permutations for interconnecting the data lines of a secondary bus 162 to one or more PEs 110 may be used within the scope of the invention. Moreover, multiple secondary busses may be identically configured by broadcasting a command across several secondary busses 162 simultaneously.

The System Bus Interface/Instruction Handler 111 may also include transceivers for moving data and instructions between the PE 110 and the secondary bus 162. A separate set of transceivers may also connect the output of the PE 110 to the System Bus Interface/Instruction Handler portion 111 for feedback purposes.

The Input Routing and Conditioning block 112 may determine the data sources for a given instruction. In contrast with conventional FPGA designs, the data source for a PE 110 of the DISP device is intentionally limited. This may result in less routing congestion, fewer unused routing resources, and superior routing. Potential data sources in a PE 110 may include, without limitation, the data lines of a secondary bus 162, the address lines of a secondary bus 162, the output data from the PE directly “above” (i.e., logically interconnected along a y-axis) the referenced PE 110 in the reconfigurable interconnect structure, the output data from the PE directly “to the left” (i.e., logically interconnected along an x-axis) of the referenced PE 110 in the reconfigurable interconnect structure, the output data from the PE diagonally “above and to the left” of the referenced PE 110 in the reconfigurable interconnect structure, and a feedback path from the referenced PE 110 itself. Note that the use of the words “above” and “to the left” does not necessarily mean physically “adjacent,” as illustrated in FIG. 3. Alternatively, other data sources may be implemented. Such other data sources will be evident to those of skill in the art and are considered to be within the scope of this invention. In a preferred embodiment, the data lines of a secondary bus 162 read by the Input Routing and Conditioning Block 112 may include bits N through N+7, where N is one of 0, 8, 16, and 24, as described above. Alternatively, other configurations of data lines of a secondary bus 162 may be used. In an embodiment, the address lines of a secondary bus 162 may be used to configure the PE 110 and/or to permit the reading or writing of data directly to or from the memory of the PE 110 by the RISC microcontroller 120 or other components of the DISP device. Signals may be passed in groups of, for example, nine bits (eight signals plus a carry/cascade signal), but may be routed on, for example, a nibble-wide (four-bit) basis. Other bit widths may be used in further embodiments.

The Input Routing and Conditioning block 112 may also include a shifter/counter circuit that may operate on, for example, individual nibbles or the entire input word simultaneously. This shift/increment/decrement functionality may permit data alignment, assist mathematical functions, and assist in the performance of specialty memory functions, such as CAM, FIFO and LIFO. The structure and sequence of the shifter/counter may be determined by the decoded instruction contained in the instruction register of the System Bus Interface/Instruction Handler 111.

In a preferred embodiment, the ALU/Memory block 113 may include a dual-ported 256×8 SRAM block and an 8-bit wide Arithmetic/Logic Unit (ALU). Other memories or functional units including, without limitation, multipliers, shift registers, memory blocks and other ALUs, may be substituted for or added to the functional units of the preferred embodiment. In addition, SRAMs and ALUs of differing sizes may be used. The memory may be programmed to compute any function of 8-inputs (data sources as listed above), or it may be used for local and/or global storage. The RISC microcontroller 120 may directly write to the memory, which may be mapped into the microcontroller's memory space. This may facilitate passing instructions and program data between the RISC microcontroller 120 and the PE 110. The memory may also be used, in conjunction with the Input Routing and Conditioning block 112, to realize sophisticated memory functions, such as CAM, FIFO, LIFO and custom memory configurations.

In a preferred embodiment, the ALU block may operate on, for example, two four-bit data sources or one eight-bit data source (plus a carry-in signal) from the Input Routing and Conditioning block 112. In the embodiment, the ALU may produce a 16-bit result (plus a carry-out signal). Typical ALU functionality including, without limitation, A+B, A−B, A>B?, and A=0? may be supported by the ALU. Alternatively, other ALU functions and ALUs of different bit widths may be used in place of or in conjunction with the preferred ALU. By combining the ALU with the memory block, additional powerful commands may be implemented. For example, a 4-bit by 4-bit multiplier may be realized in the memory block. A self-initializing circuit that uses an ALU to calculate and load memory table values for such a function is described in a co-pending patent application, entitled “Self-Configuring Processing Element,” filed Jul. 23, 2003 with serial no. (not yet assigned), which is incorporated herein by reference in its entirety. The memory block may also be loaded with values to create a high-speed “multiply-by-a-constant” function. Such a function may be used in filtering digital signal processing applications. The carry-in and cascade signals may allow the ALU/Memory blocks 113 of multiple PEs 110 to be used in conjunction with one another.

The Output Routing block 114 may route signals produced by the ALU/Memory block 113 and the Input Routing and Conditioning block 112 to subsequent PEs 110. In a preferred embodiment, the output signals, either in four or eight bit groupings, may be routed to one, some, or all of the following destinations: the data lines of the secondary bus 162 associated with the PE 110, the PE directly “above” the referenced PE 110 in the reconfigurable interconnect structure, the PE directly “to the left” of the referenced PE 110 in the reconfigurable interconnect structure, the PE diagonally “above and to the left” of the referenced PE 110 in the reconfigurable interconnect structure, and a feedback path to the PE 110 itself. In the preferred embodiment, the data portion of the secondary bus 162 written to by the Output Routing block 114 may include bits N through N+7, where N is one of 0, 8, 16, and 24, as described above. Alternatively, other configurations of data lines maybe used including different bit widths. Other potential destinations may also exist in other embodiments. Such other potential destinations will be evident to those of skill in the art after reading this description and are considered to be within the scope of this invention.

The PEs 110 are designed and optimized to be computational engines, rather than general purpose logic function engines. This optimized design represents an improvement over traditional FPGA designs using small SRAM-based look-up tables (LUTs) as their processing elements because an increased amount of processing may be performed in a PE 110 of the DISP device with significantly fewer routing resources.

In a preferred embodiment, the interconnect of a DISP device is based on a three-tier system of interconnection: the AHB 161 for direct connections to the RISC microcontroller 120, the APBs 162 to distribute those signals (and general purpose input/output signals) to the PEs 110 via individual column-oriented busses, and the toroidal interconnect for all local, PE to PE connections 170. The Local Routing resources 170 may be assigned based on specific, datapath-oriented applications. Routing may enforce a left-to-right, top-to-bottom data flow. This is in contrast to traditional FPGA designs that attempt to supply enough types and volume of routing resources to allow data to flow in any direction. The result of traditional FPGA designs is a larger than necessary die size and a large percentage of unused resources. The local routing of the DISP device may be a contiguous, non-breaking, and homogenous toroidal interconnect, which alleviates these problems.

The toroidal interconnect structure may create a virtual logic plane that is totally continuous in both the horizontal and vertical directions, and may eliminate the need for special routing rules and restrictions intrinsic to all other FPGA routing schemes. The toroidal interconnect structure is described in a co-pending U.S. patent application, entitled “Improved Interconnect Structure for Electrical Devices,” filed Jul. 23, 2003 with serial no. (not yet assigned), which is incorporated herein by reference in its entirety. Future DISP devices may use an AHB 161, APBs 162, and Local Routing resources 170 of different widths from the described embodiment.

Upon power-up, the RISC microcontroller 120 may determine if it should attempt to load an off-chip program or run a built-in self test (BIST) monitoring program. Simultaneously, the PEs 110 may self-configure to a known low-power state. The general purpose I/O pins 150 may power up in a High-Z state to avoid bus contention. Similarly, the high-speed I/O associated with the COMM blocks 140 may power up in a High-Z state. All baud rate generators, clock extraction circuitry, etc. may be either turned off or set to its lowest value. If an off-chip program is sensed by the RISC microcontroller 120, the program may set initial values for the COMM ports 140, general purpose I/Os 150, memory blocks 130 and PEs 110.

After initialization and power up, the DISP device may begin configuration and execution. The RISC microcontroller 120 may begin a “fetch, decode, execute, store” sequence, similar to a typical RISC processor. However, when required by software, pre-compiled virtual instructions that are arbitrarily wide and possibly massively parallel may be loaded into the PEs 110. All configuration controls, from routing and logical determinations to the content of the memory blocks of the PEs 110, may be directly accessible to the RISC microcontroller 120. The RISC microcontroller 120 may store the precise location and start time of the freshly loaded instructions and may add, relocate, or retire the instructions within the PEs 110 as necessary. In a preferred embodiment, the continuous, non-breaking and homogenous nature of the local interconnect structure may allow these highly application-specific instructions to be located anywhere within the array of PEs 110, without regard to the die-edge or other special conditions.

A program may be written and compiled prior to its execution on the DISP device. The DISP device, as compared to traditional solutions, may not be limited to an architecture-defined, fixed bus-width. Moreover, it may not require dedicated hardware to support legacy code. Instead, the program running on the DISP device may use an optimal instruction set for the task at hand, using the minimum number of PEs 110 and power necessary. If the current program or application exceeds the physical capacity of the DISP device, the program or application may simply pipeline reconfigure the DISP device.

Pipeline reconfiguration may permit a relatively small DISP device to replace a much larger ASIC, FPGA, or CPU. The process is shown in detail in FIG. 2 and the associated description.

With respect to the above description, it is to be realized that the optimum dimensional relationships for the parts of the invention, including variations in size, materials, shape, form, function and manner of operation, assembly and use, are readily apparent to one of skill in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operations shown and described, and accordingly, all suitable modifications and equivalents may be considered as falling within the scope of the present invention.

What is claimed is:

1. A reconfigurable processor for processing digital logic functions, comprising:
a microcontroller; and
a plurality of processing elements,
wherein the plurality of processing elements are arranged in one or more pipeline stages each comprising one or more processing elements, and
wherein the microcontroller executes a program comprising:
configuring the plurality of processing elements by sending configuration information to the plurality of processing elements,
determining whether data has been processed by the one or more processing elements of a pipeline stage, and
if data has been processed by the one or more processing elements of the pipeline stage, reconfiguring at least one of the one or more processing elements of a pipeline stage to define a subsequent pipeline stage.

2. The processor of claim 1 further comprising one or more decoders connected to the microcontroller, wherein each decoder is connected to one or more of the plurality of processing elements.

3. The processor of claim 2 further comprising one or more global interconnection busses used to connect the plurality of processing elements to the one or more decoders.

4. The processor of claim 2 wherein reconfiguring the plurality of processing elements is performed via the one or more decoders.

5. The processor of claim 1 further comprising a plurality of local interconnection busses.

6. The processor of claim 5 wherein each processing element is connected to one or more other processing elements by one or more of the local interconnection busses.

7. The processor of claim 6 wherein the plurality of processing elements are interconnected in a toroidal interconnect structure.

8. The processor of claim 1 wherein the microcontroller is in communication with a memory, and the program is stored in the memory.

9. The processor of claim 1 wherein the microcontroller is an off-chip device.

10. A method of dynamically reconfiguring a pipelined instruction set processor comprising:
configuring a plurality of pipeline stages by a microcontroller, wherein each pipeline stage includes one or more processing elements;
processing data through one or more of the plurality of pipeline stages;
reconfiguring, by the microcontroller, at least one of the one or more pipelined stages to define at least one subsequent pipeline stage; and
routing processed data through the at least one reconfigured pipeline stage.

11. The method of claim 10 wherein the reconfiguring step is performed while the processed data is further processed by the plurality of pipelined stages.

12. A reconfigurable processor for processing digital logic functions, comprising:
an on-chip microcontroller; and
a plurality of processing elements,
wherein the plurality of processing elements are arranged in one or more pipeline stages each comprising one or more processing elements, and
wherein the microcontroller executes a program comprising:
configuring the plurality of processing elements by sending configuration information to the plurality of processing elements,
determining whether data has been processed by the one or more processing elements of a pipeline stage, and
if data has been processed by the one or more processing elements of the pipeline stage, reconfiguring at least one of the one or more processing elements of a pipeline stage to define a subsequent pipeline stage.

13. The processor of claim 12 further comprising one or more decoders connected to the microcontroller, wherein each decoder is connected to one or more of the plurality of processing elements.

14. The processor of claim 13 further comprising one or more global interconnection busses used to connect the plurality of processing elements to the one or more decoders.

15. The processor of claim 13 wherein configuring the plurality of processing elements is performed via the one or more decoders.

16. The processor of claim 12 further comprising a plurality of local interconnection busses.

17. The processor of claim 16 wherein each processing element is connected to one or more other processing elements by one or more of the local interconnection busses.

18. The processor of claim 17 wherein the plurality of processing elements are interconnected in a toroidal interconnect structure.

19. The processor of claim 12 wherein the microcontroller is in communication with a memory, and the program is stored in the memory.
